(19) United States
(12) Patent Application Publication
(10) Pub. No.: US 2026/0303411 A1
(43) Pub. Date: Oct. 1, 2026

(54) COORDINATION OF CHANNEL ESTIMATION AND DECODING

(71) Applicant: Nokia Technologies Oy, Espoo (FI)

(72) Inventors: Mustafa Cemil Coskun, Murray Hill, NJ (US); Minoh Jeong, Minneapolis, MN (US); Saeed Reza Khosravirad, Murray Hill, NJ (US)

(21) Appl. No.: 19/629,277

(22) Filed: Mar. 26, 2026

Related U.S. Application Data
(60) Provisional application No. 63/779,426, filed on Mar. 28, 2025.

(30) Foreign Application Priority Data
Apr. 29, 2025 (FI) 20255352

(51) Int. Cl. H04L 25/02

(52) U.S. Cl. CPC H04L 25/0204; H04L 25/025; H04L 25/0256

(57) ABSTRACT

An apparatus, method and computer readable storage medium for coordination of channel estimation and decoding is provided. In a method, an apparatus obtains a soft estimate of a communication channel. The apparatus obtains a plurality of candidate channel estimates for the communication channel, based on the soft estimate of the communication channel. Then, the apparatus obtains at least one of a decoded signal or an estimation of the communication channel by a plurality of parallel joint channel estimation and decoding processes based on the plurality of candidate channel estimates.

### FIELD

Various example embodiments of the present disclosure generally relate to the field of telecommunication and in particular, to an apparatus, method and computer readable storage medium for coordination of channel estimation and decoding.

### BACKGROUND

Channel estimation may be used to evaluate the characteristics of a channel, including fading, delay, and multipath effects, thereby improving communication efficiency. In a process of channel estimation, a receiver may estimate characteristics of a communication channel to recover transmitted data. In a process of channel decoding, the receiver may decode the transmitted data into its original form. Joint channel estimation and decoding (JCED) is a signal processing technique used in modern communication systems to enhance accuracy and reliability of a data transmission. JCED may integrate channel estimation and data decoding to improve overall system performance.

### SUMMARY

In a first aspect of the present disclosure, there is provided an apparatus. The apparatus comprises at least one processor; and at least one memory storing instructions that, when executed by the at least one processor, cause the apparatus at least to: obtain a soft estimate of a communication channel; obtain a plurality of candidate channel estimates for the communication channel, based on the soft estimate of the communication channel; and obtain at least one of a decoded signal or an estimation of the communication channel by a plurality of parallel joint channel estimation and decoding processes based on the plurality of candidate channel estimates.

In a second aspect of the present disclosure, there is provided a method at an apparatus. The method comprises: obtaining a soft estimate of a communication channel; obtaining a plurality of candidate channel estimates for the communication channel, based on the soft estimate of the communication channel; and obtaining at least one of a decoded signal or an estimation of the communication channel by a plurality of parallel joint channel estimation and decoding processes based on the plurality of candidate channel estimates.

In a third aspect of the present disclosure, there is provided an apparatus. The apparatus comprises means for obtaining a soft estimate of a communication channel; means for obtaining a plurality of candidate channel estimates for the communication channel, based on the soft estimate of the communication channel; and means for obtaining at least one of a decoded signal or an estimation of the communication channel by a plurality of parallel joint channel estimation and decoding processes based on the plurality of candidate channel estimates.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of a frame structure of a transmitted frame;

FIG. 3 shows a flowchart of an example method implemented at the apparatus in accordance with some example embodiments of the present disclosure;

FIG. 4 illustrates an example flowchart of an example process of coordination of channel estimation and decoding in accordance with embodiments of the present disclosure;

FIG. 5 illustrates an example flowchart of an example process of coordination of channel estimation and decoding in accordance with embodiments of the present disclosure; and

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements is joined by “and” or “or”, mean at least any one of the elements, or at least any two or more of the elements, or at least all the elements.

As used herein, unless stated explicitly, performing a step “in response to A” or “responsive to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a user device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5G-advanced, the sixth generation (6G) communication protocols, wireless local network communication protocols such as Institute for Electrical and Electronics Engineers (IEEE) 802.11 and the like, and/or any other protocols either currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a user device accesses the network and receives services therefrom. The network device may refer to a base station (BS) or an access point (AP), for example, a node B (NodeB or NB), an evolved NodeB (eNodeB or eNB), an NR NB (also referred to as a gNB), a radio unit (RU), a remote radio unit (RRU), a radio head (RH), a remote radio head (RRH), a relay, an integrated access and backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture may comprise a centralized unit (CU), a distributed unit (DU) and a radio unit (RU). In some example embodiments, the RAN split architecture comprises a CU and a DU at an IAB donor node. An IAB node comprises a mobile terminal (IAB-MT) part that behaves like a UE toward the parent node, and a DU part of an IAB node behaves like a base station toward the next-hop IAB node.

The term “user device” refers to any end device that may be capable of wireless communication. By way of example rather than limitation, a user device may also be referred to as user equipment (UE), a subscriber station (SS), a portable subscriber station, a mobile station (MS), or an access terminal (AT). The user device may include, but not limited to, a mobile phone, a cellular phone, a smart phone, voice over IP (VoIP) phones, wireless local loop phones, a tablet, a wearable user device, a personal digital assistant (PDA), portable computers, desktop computer, image capture user devices such as digital cameras, gaming user devices, music storage and playback appliances, vehicle-mounted wireless user devices, wireless endpoints, mobile stations, laptop-embedded equipment (LEE), laptop-mounted equipment (LME), universal serial bus (USB) dongles, smart devices, wireless customer-premises equipment (CPE), an internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The user device may also correspond to a mobile termination (MT) part of an IAB node (e.g., a relay node). In the following description, the terms “user device”, “terminal device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a user device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

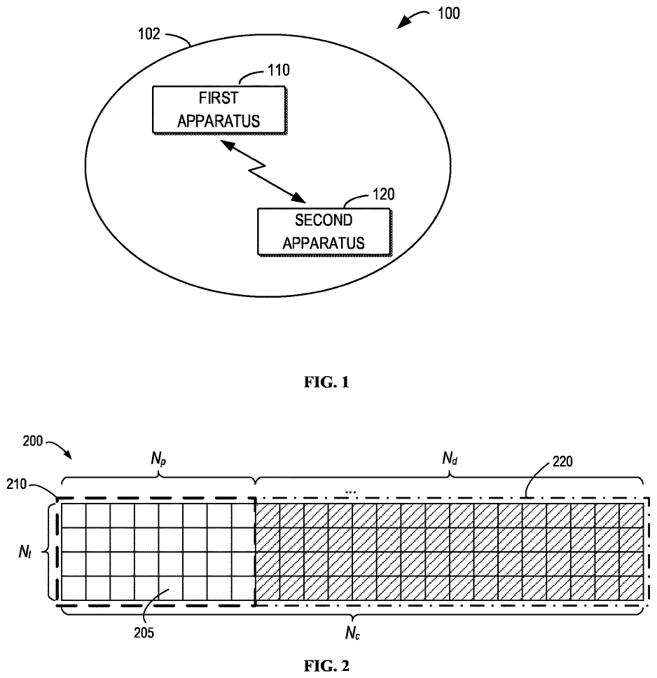

FIG. 1 illustrates an example communication environment 100 in which example embodiments of the present disclosure can be implemented. As shown in FIG. 1, the communication environment 100 may comprise a plurality of communication devices, including a first apparatus 110 and a second apparatus 120. The first apparatus 110 may operate as a terminal device (for example, a UE) and the second apparatus 120 may operate as a network device (for example, a BS or a gNB).

A serving area provided by the second apparatus 120 is called a cell 102. The first apparatus 110 may communicate with the second apparatus 120 within the cell 102. The cell 102 currently serving the first apparatus 110 may be considered as a serving cell.

It is to be understood that the number or type of apparatuses or devices and their connections shown in FIG. 1 is given for the purpose of illustration without suggesting any limitations. The communication environment 100 may include any suitable number or type of apparatuses or devices configured to implement example embodiments of the present disclosure. Although not shown, it would be appreciated that one or more additional terminal devices may be located in the cell 102, and/or one or more additional cells may be provided by the second apparatus 120.

In some example embodiments, if the first apparatus 110 is a terminal device or included in a terminal device and the second apparatus 120 is a network device or is included in a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device and the second apparatus 120 is an RX device.

Both the first apparatus 110 and the second apparatus 120 may be provided with a plurality of antennas to employ a multi-input multi-output (MIMO) technique to enhance network capacity and communication efficiency. In a MIMO system, considering a MIMO block-fading channel, a Nₜ×Nᵣ channel coefficient matrix H (Nₜ represents the number of transmit antennas and Nᵣ represents the number of receive antennas) whose elements are complex numbers, stays constant for N_{c} time instances. N_{c} generally depends on coherence time and a coherence frequency of an underlying wireless channel. The channel coefficient matrix H stays constant during a transmission of a coded message. A channel output at the i-th time instance is given as follows:

$${y}_{i} = H {x}_{i} + {n}_{i} , i = 1 , … , {N}_{c} \qquad ( 1 )$$

In Eq. (1), xᵢ represents transmitted signals, where a number of time instances occupied by xᵢ (representing the length of xᵢ in a time domain) is Nₜ, yᵢ represents received signals, where a number of time instances occupied by xᵢ (representing the length of yᵢ in a time domain) is Nᵣ, H represents a realization of the channel coefficient matrix and nᵢ represents an additive white gaussian noise (AWGN) term with a variance of 2σ²I_{N}_{ᵣ}, where I_{N}_{ᵣ} represents a Nᵣ×Nᵣ identity matrix.

If instantaneous channel state information (CSI) is known neither at a transmitter nor at a receiver, an approach for dealing with the lack of instantaneous CSI at the receiver is addressed by inclusion of a pilot (which may be orthogonal symbol sequences known to both the transmitter and the receiver) in a transmission frame. An example packet structure of a pilot-assisted transmission (PAT) is provided in FIG. 2, which illustrates a schematic diagram of a frame structure 200 of a transmitted frame. As shown in FIG. 2, each square 205 corresponds to a symbol and the frame structure 200 may be represented as X=[X^{(p)}, X^{(d)}], where X^{(p)} represents pilots (which are corresponding to a block 210) and X^{(d)} represents coded data symbols (which are corresponding to a block 220). During the first Nₚ (Nₚ≥Nₜ) time instances, pilots are transmitted. During the rest N_{d} (N_{d}=N_{c}−Nₚ) time instances, the coded data symbols are transmitted. Eq. (1) may be rewritten as follows:

$$y = H X + N \qquad ( 2 )$$

where Y=[Y^{(p)}, Y^{(d)}]∈ [symbol] ^{N}^{ᵣ}^{×N}^{_{c}}, Y^{(p)} represents received signals associated with pilots, Y^{(d)} represents received signals associated with coded data symbols, X=[X^{(p)}, X^{(d)}]∈ [symbol] ^{N}^{ₜ}^{×N}^{_{c}}, N∈ [symbol] ^{N}^{ᵣ}^{×N}^{_{c}} and N represents the AWGN term.

It is to be noted that the pilots may be transmitted in different time instances to optimize channel estimation accuracy. Before channel decoding starts, the receiver uses the pilots to estimate the CSI. Then, the CSI may be considered as perfect and used to start an efficient decoder using mismatched bit-wise soft information, such as log-likelihood ratios (LLRs). This is called PAT with mismatched decoding (PAT-MD) and such procedure is used widely in LTE and 5G NR, among other wireless technologies.

The performance of PAT may be improved via more sophisticated signal processing at the receiver. For instance, the receiver may use iterative channel estimation and decoding. These approaches are also called code-aided (for example, turbo) synchronization or parameter estimation, where an initial channel estimate is treated as noisy, and it is corrected via an underlying channel code with iterations between the channel estimation and channel decoding. Such approaches are also referred to as decision directed approaches, where the initial channel estimate is only used for an initial (hard or soft) decision on a message. Based on the hard decision, binary values (0 or 1) of the message may be provided directly. Based on the soft decision, a continuous value (such as a log-likelihood ratio, LLR) that indicates how likely bits in the message is to be a 0 or 1 may be provided.

Then, the initial decision is used to compute a new channel estimate, which leads to another decision on the message. It is observed that such iterative approaches have some issues. Firstly, latency is caused by a maximum processing delay, which is linear in the number of maximum allowed iterations between the channel estimate and the decoding. Secondly, the initial channel estimate is used for hard decision directed algorithms, where a channel code does not have an efficient decoder, providing a symbol-wise soft message. In this case, the performance may be dominated by the quality of the initial channel estimate, which requires a relatively large overhead.

The performance of PAT may be improved via JCED approaches, which consider the lack of the CSI from the beginning of the channel decoding. Such approaches require considerable changes in the decoding algorithm by embedding uncertainty of the CSI during a decoding process. Some of these approaches rely on an efficient representation of the codes via trellis, which use Viterbi or BCJR-like algorithms by combining channel and code trellis. If the underlying code does not have an efficient trellis, e.g., low-density parity-check (LDPC) or polar codes of 5G, such algorithms may not provide favorable complexity. Another JCED approach proposes to consider the imperfect CSI during successive cancellation (SC) or successive cancellation list (SCL) decoding of polar codes. However, an additional cost of computing the decoding metrics over a range of channel states may be caused. Such computation requires complexity linear in the search space of CSI in addition to the change in the decoding algorithm.

Another approach to improve the performance of PAT is to use the initial channel estimate to obtain a list of candidates which includes a transmitted message with high probability and the final decision is made by considering the pilots as a part of a codebook. In other words, the pilots may provide a good initial estimate to provide the transmitted message in a subset of codebook obtained via any list decoding algorithm. In addition, the pilots may be included in the computation of the final decision metric. However, when the length of the transmitted message is short (for example, with less bits or symbols), which is inherently the case for the applications envisioned by ultra-reliable low-latency communications (URLLCs), there is a non-negligible loss in the rate of the underlying channel code due to the inclusion of the pilots for estimating the CSI, which degrades the performance.

The JCED approaches have proven to improve a link throughput by reducing a pilot overhead for channel estimation. However, such improvement comes at high complexity costs as it is a computationally expensive task to consider the underlying channel code, especially in the case of MIMO channel where there are Nᵣ×Nₜ parameters to estimate before the channel decoding starts. Iterative approaches suffer from inevitable higher latency compared to the simple PAT-MD and require having bit-wise soft decision decoders to approach optimum performance. In addition, iterative approaches may require a large pilot overhead for a sufficiently good initial estimate dominating the performance, especially at a low to mid signal-to-noise ratio (SNR).

In accordance with some example embodiments, a solution for coordination of channel estimation and decoding is proposed. In some example embodiments, a soft estimate of a communication channel is used to obtain a plurality of candidate channel estimates for a communication channel. A plurality of joint channel estimation and decoding (JCED) processes are performed in parallel based on the plurality of candidate channel estimates, to obtain a decoded signal and/or an estimation of the communication channel.

The use of the soft estimate of the communication channel for creation of the plurality of candidate channel estimates may be more robust to noise and interference since the soft estimate retains uncertainty information of the communication channel. The parallel processing of the plurality of JCED processes may reduce latency of a channel estimation operation and a decoding operation while error accumulation may be reduced. In this way, efficiency of signal reception may be improved.

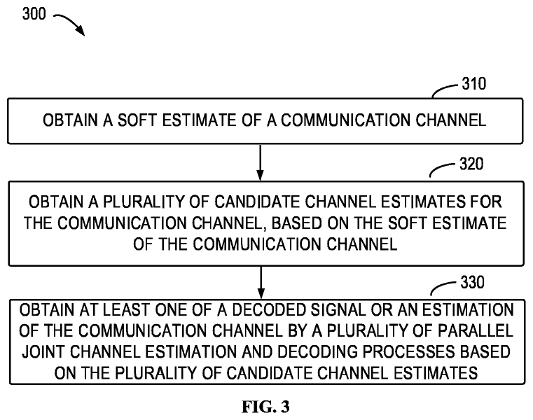

FIG. 3 shows a flowchart of an example method 300 for coordination of channel estimation and decoding in accordance with some example embodiments of the present disclosure. The method 300 may be implemented at an apparatus, e.g., the first apparatus 110 or the second apparatus 120 in FIG. 1, which may be a receiver of a communication.

At block 310, the apparatus obtains a soft estimate of a communication channel. In some examples, the communication channel may be either a channel from the second apparatus 120 (as a transmitter) to the first apparatus 110 (as a receiver) or a channel from the first apparatus 110 (as a transmitter) to the second apparatus 120 (as a receiver). In some examples, in the case where the transmitter and the receiver are provided with a plurality of antennas, for example, to enhance data transmission and reception, the channel may comprise a MIMO channel. Multiple streams may be transmitted via the MIMO channel concurrently, thereby improving data throughput. In some examples, the soft estimate may include uncertainty information of the communication channel, which retains more statistical information rather than a hard estimate.

In some example embodiments, the soft estimate of the communication channel may comprise a probability density distribution of the communication channel. The probability density distribution may be determined based on a reference channel estimate and a statistical characteristic of the communication channel. The reference channel estimate may be used as a mean value of the probability density distribution and the statistical characteristic may be used as a variance of the probability density distribution. In some examples, the probability density distribution may be represented as a Gaussian distribution, a Rayleigh distribution, or any other form of distributions. In addition to the probability density distribution, other parameters and representations of the uncertainty information of the communication channel may be used to determine the soft estimate of the communication channel. The soft estimate may enable the receiver to more comprehensively utilize the uncertainty of channel state in subsequent processing (such as channel estimation and decoding), improving overall system performance.

In some example embodiments, the probability density distribution of the communication channel may be determined based on a pilot signal (or a reference signal) which may be transmitted via the communication channel and known by both the transmitter and receiver. In some examples, the receiver may derive the probability density distribution based on pilot signals (or reference signals) X^{(p)} and observed or received pilot signals Y^{(p)}. The reference channel estimate and the statistical characteristic of the communication channel may be obtained by using a pilot signal. The probability density distribution may be related to the number of time instances occupied by the pilot signal, represented by Nₚ.

Least-square (LS), maximum-likelihood (ML) and any other suitable algorithms may be used to determine the probability density distribution. In some example embodiments, the reference channel estimate of the communication channel may comprise an LS estimate (e.g., using the LS algorithm) or a MMSE estimate (e.g., using the MMSE algorithm) of the communication channel, which may be a hard estimate of the communication channel, Ĥ. The statistical characteristic of the communication channel may comprise a noise variance of the communication channel or any other statistical characteristic of the communication channel.

Two example probability density distributions of the communication channel will be described below. In an example, the probability density distribution (denoted as \hat{f}_{H|Ĥ}) may be represented as a Gaussian distribution

$$C N ( {\hat{H}}_{L S}^{( p )} , \frac{{σ}^{2}}{{N}_{ρ}} {I}_{{N}_{r} \times {N}_{t}} ) , where {\hat{H}}_{L S}^{( p )}$$

represents the mean value of the Gaussian distribution and

$${\hat{H}}_{L S}^{( p )} = {Y}^{( p )} {{X}^{{( p )}^{T}} ( {X}^{( p )} {X}^{{( p )}^{T}} )}^{- 1}$$

is the LS estimate of the communication channel (as an example of the reference channel estimate),

$$\frac{{σ}^{2}}{{N}_{p}} {I}_{{N}_{r} \times {N}_{t}}$$

represents the noise variance of the Gaussian distribution (as an example of the statistical characteristic), Nₚ represents a number of time instances occupied by the pilot signals and I_{N}_{ᵣ}_{×N}_{ₜ} represents an identity matrix of dimensions NᵣNₜ×NᵣNₜ.

In another example, the probability density distribution may be represented as another Gaussian distribution

$$CN ( {\hat{H}}_{M M S E}^{( p )} , \frac{{σ}^{2} {N}_{p}}{{( {σ}^{2} + {N}_{p} )}^{2}} {I}_{{N}_{r} \times {N}_{t}} ) , where {\hat{H}}_{M M S E}^{( p )}$$

represents the mean value of the Gaussian distribution and

$${\hat{H}}_{M M S E}^{( p )} = {\hat{H}}_{LS}^{( p )} {X}^{( p )} {{X}^{{( p )}^{T}} ( {X}^{( p )} {X}^{{( p )}^{T}} + {σ}^{2} {I}_{{N}_{r} \times {N}_{t}} )}^{- 1}$$

is the MMSE estimate of the communication channel (as an example of the reference channel estimate),

$$\frac{{σ}^{2} {N}_{p}}{{( {σ}^{2} + {N}_{p} )}^{2}} {I}_{{N}_{r} \times {N}_{t}}$$

represents the noise variance of the Gaussian distribution (as an example of the statistical characteristic).

In these examples, the reference channel estimate

$$( e . g . , {\hat{H}}_{L S}^{( p )} or {\hat{H}}_{M M S E}^{( p )} )$$

and the statistical characteristic

$$( e . g . , \frac{{σ}^{2}}{{N}_{ρ}} {I}_{{N}_{r} \times {N}_{t}} \frac{{σ}^{2} {N}_{p}}{{( {σ}^{2} + {N}_{p} )}^{2}} {I}_{{N}_{r} \times {N}_{t}} )$$

of the communication channel are derived based on the pilot signal X^{(p)}. In addition, the probability density distribution may be related to Nₚ, which is a component of the statistical characteristic.

At block 320, the apparatus obtains a plurality of candidate channel estimates for the communication channel, based on the soft estimate of the communication channel. In some examples, in the example embodiments where the soft estimate comprises the probability density distribution of the communication channel, the plurality of candidate channel estimates may be generated by randomly sampling via the probability density distribution.

In some other example embodiments, one of the plurality of candidate channel estimates may be a mean value in the probability density distribution. For example, the plurality of candidate channel estimates may be represented as a list [symbol] ={Ĥ₁, Ĥ₂, . . . , [symbol] }, where Ĥ₁ to [symbol] represent the candidate channel estimates. In some examples, a candidate channel estimate (e.g., Ĥ₁) may be set as the mean value of the probability density distribution. Other candidate channel estimates (e.g., Ĥᵢ, i∈{2, 3, . . . , | [symbol] |}) may be randomly sampled via the probability density distribution. By setting a candidate channel estimate as the mean value of the probability density distribution, the plurality of candidate channel estimates may better capture the characteristic of the communication channel. It is only illustrative to use the mean value in the probability density distribution as one candidate channel estimate, without suggesting any limitation. It is possible that other statistical values in the probability density distribution are selected as candidate channel estimates. For example, in some example embodiments, a median in the probability density distribution may be selected as a candidate channel estimate.

In some example embodiments, a number of the candidate channel estimates may be associated with a certainty of the soft estimate. For example, a list size of [symbol] may be dynamically determined at the receiver based on the certainty of the soft estimate. In some examples, more candidate channel estimates may be determined if the soft estimate is of low certainty. In this way, more candidate channel estimates may be used for low-certainty channel estimation to improve reliability of the subsequent channel estimation and decoding process.

In some examples, the certainty of the soft estimate may be related to the noise variance of the communication channel. The smaller the noise variance is, the larger the certainty of the soft estimate is. Alternatively, or in addition, the certainty of the soft estimate may be related to the number of time instances occupied by the pilot signal (e.g., Nₚ). The more time instances of the pilot signals, the larger the certainty of the soft estimate may be provided. Taking the probability density distribution as an example of the soft estimate, if the certainty of the soft estimate is larger (the uncertainty is small), a small number of candidate channel estimates may be enough to capture characteristics of the communication channel.

In some examples, Nₚ may be determined together with a code block length, a coding rate and a modulation order which may be applied for either or both of the pilots and data transmission, to improve performance and efficiency of the channel estimation and the data transmission. In some examples, Nₚ may be related to a length of a coherent resource block, for example, in a time domain, where the channel characteristics may be considered constant within the coherence resource block. In an example, a length of a coherent resource block, denoted as N_{c} that may represent the number of time instances of the channel may be greater than the number of time instances occupied by the pilot signal (for example, N_{c}>Nₚ), such that after allocating pilot resources, there are still resources left for data transmission. The number of time instances occupied by the pilot signal may be greater than or equal to the number of transmit antennas (for example, Nₚ>Nₜ). In this way, each transmit antenna may transmit at least one pilot for the receiver to estimate the channel, thereby improving the channel estimation performance. In an example, the number of time instances occupied by the pilot signal may be set as a small value, for example, determined as the number of transmit antennas (e.g., Nₚ=Nₜ) since using more pilots may cause degradation in JCED performance.

At block 330, the apparatus obtains at least one of a decoded signal (e.g., a codeword) or an estimation of the communication channel by a plurality of parallel JCED processes based on the plurality of candidate channel estimates. In some examples, a JCED process of the plurality of parallel JCED processes may be performed based on a candidate channel estimate of the plurality of candidate channel estimates. For example, the receiver may obtain a plurality of candidate decoded signals based on the plurality of candidate channel estimate in parallel, and then determine a pair of a candidate channel estimate and a candidate decoded signal as a final result of the estimation of the communication channel and the decoded signal. The parallel JCED processes for the plurality of candidate channel estimates may reduce processing latency.

Upon reception of the signal, the receiver may first perform a signal detection process on a received signal to obtain a detected signal (which may be represented as e.g., bitwise LLRs of each received bit) and then perform a decoding process on the detected signal to obtain the decoded signal. In some example embodiments, the decoded signal may be obtained by the plurality of parallel JCED processes for a plurality of detected signals and the plurality of detected signals may be obtained by a plurality of parallel signal detection processes based on the plurality of candidate channel estimates. One of the plurality of detected signals may be obtained by performing one of the plurality of parallel signal detection processes based on one of the plurality of candidate channel estimates. In some examples, for each candidate channel estimate, a detector may be used to obtain bitwise LLRs, which indicate the probability of each bit in a received signal being 0 or 1. A plurality of detectors may be run in parallel for the plurality of candidate channel estimates. The detector may be any suitable detector, e.g., a MMSE detector, a MMSE-parallel interference cancellation (MMSE-PIC) detector, a maximum likelihood (ML) detector, and/or the like. Such parallel signal detection may further improve the processing efficiency.

In some example embodiments, the transmitter and the receiver may be provided with a plurality of antennas. In this case, the plurality of parallel signal detection processes may comprise a plurality of parallel MIMO detection processes. In a MIMO detection process, signals are received by a plurality of antennas and a MIMO detector may analyze the received signals to obtain bitwise LLRs.

In some example embodiments, the decoded signal may be obtained based on respective metrics of the plurality of candidate channel estimates. A metric of a candidate channel estimate of the plurality of candidate channel estimates may be associated with both the candidate channel estimate and a candidate decoded signal corresponding to the candidate channel estimate. Based on the respective metrics of the candidate channel estimates, a candidate channel estimate and a candidate decoded signal may be determined as the final result of the estimation of the communication channel and the decoded signal.

The metric may be computed in any suitable way. In some examples, for different types of decoding or decoders, there are different approaches to compute the metric. An approach to compute the metric for a list decoder and another approach to compute the metric for a hard-decision decoder are shown as follows:

$$\begin{matrix}\hat{H} = {arg max}_{H ∈ {ℂ}^{{N}_{r} \times {N}_{t}}} - {‖ {Y}^{( p )} - H {X}^{( p )} ‖}_{F}^{2} + ( 3 ) \\ 2 {σ}^{2} ln {\sum }_{{X}^{( d )} ∈ ℒ ( {Y}^{( d )} , H )} {e}^{- \frac{1}{2 {σ}^{2}} {‖ {Y}^{( d )} - H {X}^{( d )} ‖}_{F}^{2}} , \\ \approx {arg max}_{H ∈ {ℂ}^{{N}_{r} \times {N}_{t}}} - {‖ {Y}^{( p )} - H {X}^{( p )} ‖}_{F}^{2} - {‖ {Y}^{( d )} - H {\tilde{X}}^{( d )} ( H ) ‖}_{F}^{2} ( 4 )\end{matrix} .$$

The expression in the formular (3) is used to compute the metrics for a list of decoded signals obtained by the list decoder. The list decoding may be useful in noisy conditions as it may enhance the probability of recovering the correct codeword by providing multiple possibilities. The expression in the formular (4) is used to compute the metric for a candidate decoded signal obtained by the hard-decision decoder. Hard-decision decoding may improve the efficiency of channel estimation and decoding for high-speed communications or resource-constrained devices.

In the formular (3) and the formular (4), Y^{(p)} represents a received pilot signal, and X represents a transmitted pilot signal. In the formular (3), [symbol] (Y^{(d)}, H)⊆ [symbol] is a list of codewords (as examples of the candidate decoded signals) of the codebook C obtained via any list decoding algorithm corresponding to the received signal Y^{(d)} and the assumed CSI H which may be included in the list [symbol] ={Ĥ₁, Ĥ₂, . . . , [symbol] } of | [symbol] | candidates, where Ĥᵢ is generated according to \hat{f}_{H|\ddot{H}} (representing the probability density distribution of the channel as an example of the soft estimate of the channel), as described above. [symbol] (Y^{(d)}, H) may also be represented as [symbol] (Y^{(d)}, Ĥᵢ). In the formular (4), \tilde{X}^{(d)}(H) is a codeword estimate (as an example of the candidate decoded signal) obtained via any decoding algorithm for the assumed CSI hypothesis by the matrix H. Both the formulars (3) and (4) return a channel estimate Ĥ (as an example of the estimation of the communication channel) together with a list of candidates [symbol] (Y^{(d)}, H) and a codeword estimate \hat{X}^{(d)}(Ĥ) (as an example of the decoded signal), respectively. Hence, the joint channel estimation and decoding may be implemented. For the proposed estimator, the search space is over a Nᵣ×Nₜ dimensional complex coordinate space, denoted as [symbol] ^{N}^{ᵣ}^{×N}^{ₜ}. This is where the soft estimate \hat{f}_{H|Ĥ} comes.

In some example embodiments, a priority may be assigned to a candidate channel estimate of the plurality of candidate channel estimates. In some examples, respective weighting vectors may be generated to capture importances of respective candidate channel estimates in the plurality of candidate channel estimates, for example, in a form of likelihood. Different weighting vectors may indicate different priority levels. In some examples, the JCED processes may be performed for the candidate channel estimates in case the total available parallel processing capacity is smaller than | [symbol] |. For example, the receiver may determine the priorities of those candidate channel estimates (also called channel samples) based on the weighting vectors. A candidate channel estimate with a small weighting vector may be discarded. By assigning a priority to a candidate channel estimate of the plurality of candidate channel estimates, the JCED may be performed more efficiently.

A cyclic redundancy check (CRC) may be used to detect errors that may occur during signal transmission. By using the CRC, the transmitter may generate a checksum, which is appended to transmitted data. Upon receiving the data, the receiver may recalculate the checksum and compare it with the received checksum to detect errors in the transmitted data. In some example embodiments, the CRC may be used to determine a success of a JCED process of the plurality of parallel JCED processes. If the checksum calculated by receiver matches the checksum transmitted by the transmitter, the JCED process may be considered successful.

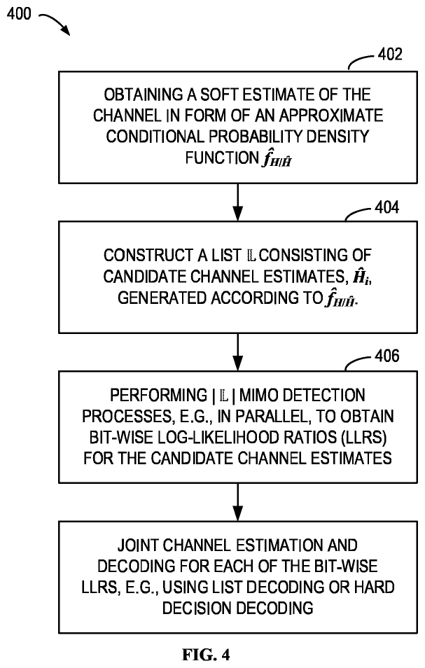

An example process of coordination channel estimation and decoding will be introduced with reference to FIG. 4.

As shown in FIG. 4, in a process 400, at block 402, a receiver (e.g., the first apparatus 110 or the second apparatus 120) may obtain a soft estimate of a communication channel in form of an approximate conditional probability density function using pilot signals. After observing the communication channel, the transmitted pilot signals X^{(p)} and the received pilot signals Y^{(p)} are used to derive distributions (as an example of the soft estimate) via two options. In a first option, an LS or ML soft channel estimate may be derived. The distribution \hat{f}_{H|Ĥ} may be adopted as

$$C N ( {\hat{H}}_{L S}^{( p )} , \frac{{σ}^{2}}{{N}_{p}} {I}_{{N}_{r} \times {N}_{t}} ) , where {\hat{H}}_{L S}^{( p )} = {Y}^{( p )} {{X}^{{( p )}^{T}} ( {X}^{( p )} {X}^{{( p )}^{T}} )}^{- 1}$$

is the LS estimate (as an example of the hard estimate) of the communication channel. In a second option, a MMSE soft channel estimate may be derived. The distribution \hat{f}_{H|Ĥ} may be adopted as

$$CN ( {\hat{H}}_{M M S E}^{( p )} , \frac{{σ}^{2} {N}_{p}}{{( {σ}^{2} + {N}_{p} )}^{2}} {I}_{{N}_{r} \times {N}_{t}} ) , where$$

$${\hat{H}}_{M M S E}^{( p )} = {\hat{H}}_{LS}^{( p )} {X}^{( p )} {{X}^{{( p )}^{T}} ( {X}^{( p )} {X}^{{( p )}^{T}} + {σ}^{2} {I}_{{N}_{r} \times {N}_{t}} )}^{- 1}$$

is the MMSE estimate of the communication channel.

At block 404, the receiver may construct a list of candidate channel estimates for the communication channel based on the soft estimate. After obtaining the soft estimate at block 402 via any options, a list of candidate channel estimates (denoted as [symbol] ={Ĥ₁, Ĥ₂, . . . , [symbol] }) may be generated, where its members may be generated as follows. In an example, Ĥ₁ is set as the mean value of the adopted distribution \hat{f}_{H|Ĥ}. Then, each Ĥᵢ, i∈{2, 3, . . . , [symbol] } may be generated by randomly sampling via the distribution \hat{f}_{H|Ĥ}.

At block 406, the receiver may perform a plurality of MIMO detection processes, using a detector, in parallel to obtain bit-wise LLRs for the list of candidate channel estimates. For each candidate channel estimate Ĥᵢ, a MIMO detector is used to obtain bitwise LLRs. The detector can be any standard detector, e.g., a MMSE detector, a MMSE-PIC detector or a ML detector. In a simulation the verify the performance of the proposed solution, an unbiased MMSE detector may be used. There may be a plurality of MIMO detectors for the list [symbol] and the plurality of MIMO detectors may run in parallel, which may reduce the latency of the detection process.

At block 408, for each candidate channel estimate Ĥᵢ, the receiver may perform a JCED process based on the bit-wise LLRs corresponding to Ĥᵢ, using list decoding or hard-decision decoding, to obtain the decode signal. In the examples where list decoding is utilized, the formular (3) may be used. For each Ĥᵢ, the obtained LLRs are fed to the corresponding list decoder. For each Ĥᵢ, the list decoder is used to obtain a list of codewords [symbol] (Y^{(d)}, Ĥᵢ). Then, a pair of the candidate channel estimate Ĥᵢ and the candidate decoded signal (also referred to as codeword estimate) \hat{X}^{(d)}(Ĥᵢ) (picked among [symbol] (Y^{(d)}, Ĥᵢ)) which maximizes the expression in the formular (3) may be determined as the final result of the estimation of the communication channel and the decoded signal. In the examples where hard-decision decoding is utilized, the formular (4) may be used. For each Ĥᵢ, the obtained LLRs are fed to the corresponding hard-decision decoder. For each Ĥᵢ, the hard-decision decoder is used to obtain a codeword estimate X^{(d)}(Ĥᵢ). The pair of the candidate channel estimate Ĥᵢ and the candidate decoded signal \hat{X}^{(d)}(Ĥᵢ) which maximizes the expression in the formular (4) may be determined as the final result of the estimation of the communication channel and the decoded signal. The process 400 may result in a much more controlled approach to achieve global optimal solution to the channel estimation problem, as opposed to the conventional solution which is likely to get stuck in local minima.

In some example embodiments, the process of coordination channel estimation and decoding (e.g., the process 400) may be performed iteratively. In some examples, when none of the parallel JCED processes are successful, the process of coordination channel estimation and decoding may be performed iteratively. Whether a JCED process is successful may be determined based on the CRC, as described above. In case none of the candidate decoded signals provide a correct CRC, that is, none of the parallel JCED processes are successful, the process may be performed iteratively.

In some example embodiments, whether the process of coordination channel estimation and decoding is performed iteratively may be based on respective costs of the plurality of parallel JCED processes. In some example embodiments, a cost of a JCED process may comprise a channel estimation cost. The channel estimation cost may be indicated by resource overhead required to accurately estimate the characteristics of the communication channel. In some examples, the channel estimation cost may be indicated by a computing cost of executing channel estimation algorithms (e.g., LS or MMSE algorithm), overhead of pilot signals, latency of the channel estimation process and/or the like.

Alternatively, or in addition, the cost of a JCED process may comprise a channel decoding cost. The channel decoding cost may be indicated by resource overhead required to recover transmitted data from a noisy or distorted received signal in the communication channel. In some examples, the channel decoding cost may be determined based on a computing cost of channel decoding algorithms (e.g., Turbo decoding or LDPC decoding), a storage cost of storing intermediate results (e.g., channel estimates, LLRs), latency of iterative refinement of channel estimation and decoding decisions and/or the like.

In some example embodiments, the apparatus may determine respective costs of the plurality of parallel JCED processes. If none of the costs are lower than a first threshold, the apparatus may update the soft estimate based on a candidate channel estimate of the plurality of candidate channel estimates corresponding to a cost of the costs lower than a second threshold. In some examples, if at least one cost is lower than the first threshold, the process of coordination channel estimation and decoding may not be performed iteratively. Otherwise, the process may be performed iteratively, and the soft estimate may be updated based on a candidate channel estimate corresponding to a cost (e.g., a minimum cost higher than the first threshold) lower than a second threshold. A new list of candidate channel estimates may be constructed based on the updated soft estimate. In an example, the updated soft estimate may include an updated probability density distribution of the communication channel and the candidate channel estimate corresponding to the cost lower than the second threshold may be taken as the mean value of the updated probability density distribution. The first and second thresholds may be set by considering any suitable factors such as a trade-off between latency due to the iteration and performance of the JCED.

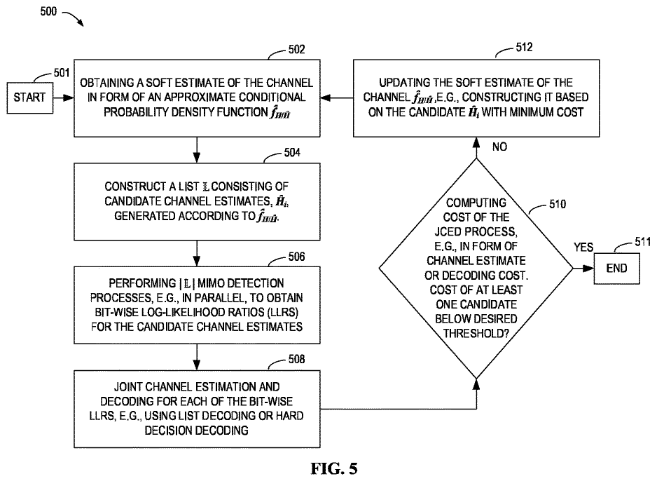

An example process of iteratively performing parallel JCEC processes will be introduced with reference to FIG. 5.

Blocks 502 to 508 are similar to blocks 402 to 408, and details thereof will not be repeated. In some example embodiments, at block 504 where the receiver constructs a list of candidate channel estimates (denoted as [symbol] ={Ĥ₁, Ĥ₂, . . . , [symbol] }) for the communication channel based on the soft estimate, the list size [symbol] of may be dynamically determined at the receiver based on the certainty of the soft estimate, e.g., determined based on σ² (e.g., a noise variance of the channel) and Nₚ (e.g., the number of time instances occupied by the pilot signal). This allows the receiver to, e.g., allocate more parallel processing capability to faded packets with low certainty of channel estimation to improve reliability of the signal detection and/or decoding process. The number of (orthogonal) pilots Nₚ may be selected together with the code block length, a coding rate, and a modulation order such that N_{c}>Nₚ>Nₜ, where N_{c} represents a length of a coherent resource block (for example, the number of time instances of the channel) and Nₜ represents the number of transmit antennas. In an example, Nₚ=Nₜ may be set as using more pilots may result in degradation in a best achievable performance. The receiver may approach the best achievable performance by increasing the size of [symbol] as needed.

In some example embodiments, at block 504, a weighting vector of the size (or length) of [symbol] may be generated that captures the importance of the samples in the list of candidate channel estimate, e.g., in form of likelihood. Then, at blocks 506 and 508, a priority of those samples may be determined based on the weighting vector, e.g., in case the total available parallel processing capacity is smaller than the length of [symbol] .

In some example embodiments, a CRC check may be used with the decode signal. During the decoding process at block 508, the CRC check of the codeword may be used to determine success or failure of the JCED process.

In some example embodiments, for use cases with less critical latency requirements, the complexity of the JCED process may be further reduced as follows. An initial small number of [symbol] may be used at block 502. At the end of block 508, the cost of the JCED process may be computed using the initial small number of [symbol] , and then in case none of the candidate channel estimate provides a correct CRC check, the candidate with minimum cost is selected and used as Ĥ and the process 500 may be performed iteratively from the block 502.

In some example embodiments, whether the process 500 is performed iteratively may be based on respective costs of the plurality of parallel JCED processes. At block 510, the receiver may compute costs of the plurality of JCED processes and determine whether at least one cost is lower than a desired threshold (e.g., the first threshold). In some examples, costs of the plurality of JCED processes may include at least one of a channel estimation cost or a decoding cost. If the at least one cost is lower than the first threshold, the process may not be performed iteratively. Then, at block 511, the process 500 may end. Otherwise, the process 500 may proceed to block 512.

At block 512, the receiver may update the soft estimate based on a candidate channel estimate with a minimum cost higher than the first threshold (e.g., the cost lower than the second threshold). In an example, the updated soft estimate may include an updated probability density distribution of the communication channel and the candidate channel estimate may be taken as the mean value of the updated probability density distribution. Then, blocks 502 to 508 may be performed iteratively. In some example embodiments, the number of iterations and the number of the candidate channel estimates may be determined to optimize a trade-off between the latency and the performance of the coordination channel estimation and decoding. If the latency requirement is not critical, the number of iterations and the number of the candidate channel estimates may be increased to improve the performance of the process.

The simulation results show that the proposed solutions may achieve better performance. In the simulation, Nᵣ=8, Nₜ=4, Nₚ=4, and N_{c}=20 and a Rayleigh fading channel is considered. Short polar codes designed according to 5G reliability sequence are used in the simulations, where the length of the code block is chosen to be 128 bits, the coding rate R is set to 0.25 and quadrature phase shift keying (QPSK) signalling with Gray labelling is used. In the case where a MMSE soft channel estimation with random list generation, a frame error rate (FER) of a receiver using the proposed solutions provides more gains compared to a PAT-MD scheme under SC decoding. The proposed solutions result in a much more controlled approach to achieve global optimal solution to the channel estimation problem, as opposed to the conventional solution which is likely to get stuck in local minima. It is to be noted that although the simulation results are provided using polar codes, the proposed solutions also work for other codes, for example, LDPC or Reed-Muller codes.

In some example embodiments, an apparatus capable of performing any of the method 300 (for example, the first apparatus 110 or the second apparatus 120 in FIG. 1) may comprise means for performing the respective operations of the method 300 and any of the embodiments thereof. The means may be implemented in any suitable form. For example, the means may be implemented in a circuitry or software module. The apparatus may be implemented as or included in the first apparatus 110 or the second apparatus 120 in FIG. 1.

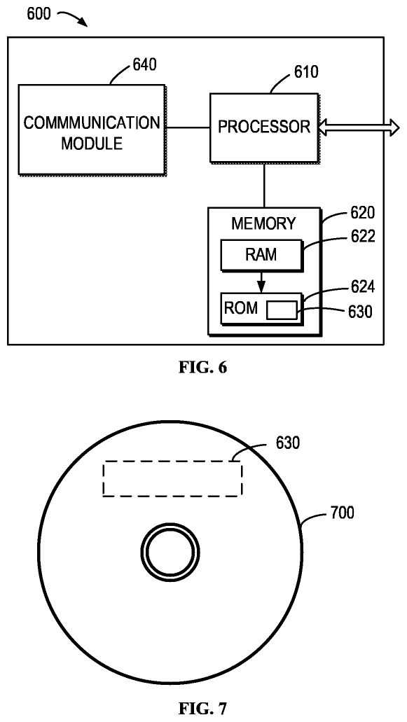

FIG. 6 is a simplified block diagram of a device 600 that is suitable for implementing example embodiments of the present disclosure. The device 600 may be provided to implement a communication device, for example, the first apparatus 110 and the second apparatus 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 1 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
obtain a soft estimate of a communication channel;
obtain a plurality of candidate channel estimates for the communication channel, based on the soft estimate of the communication channel; and
obtain, by a plurality of parallel joint channel estimation and decoding processes based on the plurality of candidate channel estimates, at least one of a decoded signal or an estimation of the communication channel.

2. The apparatus of claim 1, wherein the soft estimate of the communication channel comprises a probability density distribution of the communication channel, and the probability density distribution of the communication channel is determined based on a reference channel estimate and a statistical characteristic of the communication channel.

3. The apparatus of claim 2, wherein the reference channel estimate of the communication channel comprises a least-square estimate or a minimum mean-squared error estimate of the communication channel.

4. The apparatus of claim 2, wherein the statistical characteristic of the communication channel comprises a noise variance of the communication channel.

5. The apparatus of claim 2, wherein the reference channel estimate and the statistical characteristic of the communication channel are obtained by using a pilot signal, and the probability density distribution is related to a number of time instances occupied by the pilot signal.

6. The apparatus of claim 2, wherein one of the plurality of candidate channel estimates is a mean value in the probability density distribution.

7. The apparatus of claim 1, wherein
the decoded signal is obtained by the plurality of parallel joint channel estimation and decoding processes for a plurality of detected signals, and
the plurality of detected signals are obtained by a plurality of parallel signal detection processes based on the plurality of candidate channel estimates, wherein one of the plurality of detected signals is obtained by performing one of the plurality of parallel signal detection processes based on one of the plurality of candidate channel estimates.

8. The apparatus of claim 7, wherein the plurality of parallel signal detection processes comprise a plurality of parallel multiple input multiple output (MIMO) detection processes.

9. The apparatus of claim 1, wherein the decoded signal is obtained based on respective metrics of the plurality of candidate channel estimates, and a metric of a candidate channel estimate of the plurality of candidate channel estimates is associated with both the candidate channel estimate and a candidate decoded signal corresponding to the candidate channel estimate.

10. The apparatus of claim 1, wherein a number of the candidate channel estimates is associated with a certainty of the soft estimate.

11. The apparatus of claim 1, wherein a priority is assigned to a candidate channel estimate of the plurality of candidate channel estimates.

12. The apparatus of claim 1, wherein a cyclic redundancy check is used to determine a success of a joint channel estimation and decoding process of the plurality of parallel joint channel estimation and decoding processes.

13. The apparatus of claim 1, wherein a joint channel estimation and decoding process of the plurality of parallel joint channel estimation and decoding processes comprises list decoding or hard-decision decoding.

14. The apparatus of claim 1, wherein the apparatus is further caused to:
determine respective costs of the plurality of parallel joint channel estimation and decoding processes; and
in accordance with a determination that none of the costs is lower than a first threshold, update the soft estimate based on a candidate channel estimate of the plurality of candidate channel estimates corresponding to a cost of the costs lower than a second threshold.

15. The apparatus of claim 14, wherein a cost of the costs comprises at least one of a channel estimation cost or a decoding cost.

16. A method comprising:
at an apparatus,
obtaining a soft estimate of a communication channel;
obtaining a plurality of candidate channel estimates for the communication channel, based on the soft estimate of the communication channel; and
obtaining, by a plurality of parallel joint channel estimation and decoding processes based on the plurality of candidate channel estimates, at least one of a decoded signal or an estimation of the communication channel.

17. (canceled)

18. A computer readable medium comprising instructions stored thereon for causing an apparatus at least to perform the method of claim 16.
